(19) United States
(12) Patent Application Publication
(10) Pub. No.: US 2024/0144912 A1
(43) Pub. Date: May 2, 2024

(54) LEARNING APPARATUS, ESTIMATION APPARATUS, METHODS AND PROGRAMS FOR THE SAME

(71) Applicant: NIPPON TELEGRAPH AND TELEPHONE CORPORATION, Chiyoda-ku (JP)

(72) Inventors: Junji WATANABE, Tokyo (JP); Aiko MURATA, Tokyo (JP)

(73) Assignee: NIPPON TELEGRAPH AND TELEPHONE CORPORATION, Tokyo (JP)

(21) Appl. No.: 18/280,159

(22) PCT Filed: Mar. 10, 2021
(86) PCT No.: PCT/JP2021/009525

§ 371 Date: Sep. 1, 2023

(51) Int. Cl. G10L 15/04; G10L 15/02; G10L 15/06

(52) U.S. Cl. CPC G10L 15/04; G10L 15/02; G10L 15/063

(57) ABSTRACT

An estimation apparatus includes an estimation unit that estimates a future incident occurrence quantitative value in a region on the basis of at least two or more inputted psychological-state/sensibility expressing words emitted in a predetermined region and the input order of the two or more psychological-state/sensibility expressing words, using an estimation model for estimating an incident occurrence quantitative value that is a quantitative value of an occurrence of a predetermined event in the region after a certain time, with an input being at least a time series of two or more psychological-state/sensibility expressing words emitted in the predetermined region before the certain time.

### TECHNICAL FIELD

The present invention relates to a technology for estimating an occurrence frequency, an occurrence rate, and the like of a predetermined event that occurs in society, from psychological-state/sensibility expressing words including onomatopoeia.

### BACKGROUND ART

According to Non Patent Literature 1, an entire impression of onomatopoeia is quantified by a model that predicts an impression of onomatopoeia from phonological factors such as the types of consonants and vowels constituting the onomatopoeia and the presence/absence of a dull sound.

### CITATION LIST

### Non Patent Literature

Non Patent Literature 1: Yuichiro Shimizu, Ryuichi Doizaki, and Maki Sakamoto, “System to Estimate an Impression Conveyed by Onomatopoeia”, Journal of the Japanese Society for Artificial Intelligence, Vol. 29, No. 1, pp. 41-52, 2014

### SUMMARY OF INVENTION

### Technical Problem

By the technique disclosed in Non Patent Literature 1, an impression conveyed by onomatopoeia is estimated. However, the technique disclosed in Non Patent Literature 1 does not estimate the occurrence frequency, the occurrence rate, and the like of a predetermined event (hereinafter also referred to as an “incident”, for convenience) that occurs in the society to which users who use onomatopoeia belong. The present invention aims to provide an estimation apparatus that estimates quantitative values such as an occurrence frequency and an occurrence rate of an incident that will occur in the future in society (such quantitative values will be hereinafter also referred to as “incident occurrence quantitative values”, for convenience) on the basis of psychological-state/sensibility expressing words till the present, a learning apparatus that learns the model that is used in estimating incident occurrence quantitative values in the future, methods implemented by those apparatuses, and a program.

Note that a psychological-state/sensibility expressing word indicates the psychological state of a subject person at a certain point of time, and is a generic term for words categorized into onomatopoeia and/or exclamation, for example. Further, onomatopoeia is a generic term for words categorized as at least one of an imitative word, a mimetic word, or a psychomime, for example. Here, an imitative word expresses an actual sound with a verbal sound, a mimetic word expresses a feeling that is not a sound with a verbal sound, and a psychomime expresses a psychological state with a verbal sound. Note that exclamation may be called interjections. In the description below, cases where psychological-state/sensibility expressing words are onomatopoeia will be described, but the same processing can be performed in a case where psychological-state/sensibility expressing words are exclamation.

Further, an incident is a predetermined event that occurs due to an activity of a person or interactions between persons, can be quantified as an occurrence frequency, an occurrence rate, and the like, and is accumulated or counted for each time or region. An occurrence frequency is the number of occurrences of incidents per certain time in a target region, and an occurrence rate is the value obtained by dividing the occurrence frequency by the number of people in the target region. Incident occurrence quantitative values may be the number of crimes, the number of traffic accidents, the number of harassments, the number of contributions, and the voting rate on a specific day in a certain region, for example.

### Solution to Problem

To solve the above problem, a learning apparatus according to one mode of the present invention includes: a storage unit that stores at least a learning psychological-state/sensibility expressing word emitted in a predetermined region, and a learning incident occurrence quantitative value that is a quantitative value of an occurrence of a predetermined event that occurred in the region when the learning psychological-state/sensibility expressing word was emitted; and a learning unit that learns an estimation model for estimating an incident occurrence quantitative value after a certain time in the region, using a plurality of sets of learning data, one set of learning data being a combination including at least a time series of two or more learning psychological-state/sensibility expressing words emitted in the region before a time time(t) and a learning incident occurrence quantitative value in the region after the time time(t), with an input being at least a time series of two or more psychological-state/sensibility expressing words emitted before the certain time in the region.

To solve the above problem, an estimation apparatus according to another mode of the present invention includes an estimation unit that estimates a future incident occurrence quantitative value in a region on the basis of at least two or more inputted psychological-state/sensibility expressing words emitted in the region and the input order of the two or more psychological-state/sensibility expressing words, using an estimation model for estimating an incident occurrence quantitative value that is a quantitative value of an occurrence of a predetermined event in the region after a certain time, with an input being at least a time series of two or more psychological-state/sensibility expressing words emitted in the predetermined region before the certain time.

To solve the above problem, a learning apparatus according to another mode of the present invention includes: a storage unit that stores at least a learning psychological-state/sensibility expressing word emitted by a plurality of persons in a predetermined region, a time for learning at which the learning psychological-state/sensibility expressing word was emitted, and a learning incident occurrence quantitative value that is a quantitative value of an occurrence of a predetermined event that occurred in the region when the learning psychological-state/sensibility expressing word was emitted; and a learning unit that learns an estimation model for estimating an incident occurrence quantitative value after a certain time in the region, using a plurality of sets of learning data, one set of learning data being a combination including at least a plurality of learning psychological-state/sensibility expressing words emitted by a plurality of persons in the region before a time time(t), times for learning corresponding to the respective learning psychological-state/sensibility expressing words or elapsed times since a predetermined time, and a learning incident occurrence quantitative value after the time time(t) in the region, with inputs being at least a plurality of psychological-state/sensibility expressing words emitted by a plurality of persons in the region before the certain time, and times corresponding to the respective psychological-state/sensibility expressing words or elapsed times since a predetermined time.

To solve the above problem, an estimation apparatus according to another mode of the present invention includes an estimation unit that estimates a future incident occurrence quantitative value in a region on the basis of at least a plurality of psychological-state/sensibility expressing words emitted by a plurality of persons in the region, and times corresponding to the respective psychological-state/sensibility expressing words or elapsed times since a predetermined time, using an estimation model for estimating an incident occurrence quantitative value that is a quantitative value of an occurrence of a predetermined event in the region after a certain time, with inputs being at least a plurality of psychological-state/sensibility expressing words emitted by a plurality of persons before the certain time in the predetermined region, and times corresponding to the respective psychological-state/sensibility expressing words or elapsed times since a predetermined time.

### Advantageous Effects of Invention

According to the present invention, quantitative values such as the number of occurrences, the occurrence frequency, and the occurrence rate of a predetermined event that occur in the future in society can be estimated on the basis of the psychological-state/sensibility expressing words collected till the present.

### BRIEF DESCRIPTION OF DRAWINGS

FIG. 1 is a diagram illustrating an example configuration of an estimation system according to a first embodiment.

FIG. 2 is a functional block diagram of a learning apparatus according to the first embodiment.

FIG. 3 is a diagram showing a processing flow of the learning apparatus according to the first embodiment.

FIG. 4 is a diagram illustrating an example of data stored in a storage unit.

FIG. 5 is a diagram for explaining an estimation model.

FIG. 6 is a functional block diagram of an estimation apparatus according to the first embodiment.

FIG. 7 shows an example processing flow of the estimation apparatus according to the first embodiment.

FIG. 8 is a diagram illustrating an example of data stored in a transitory storage unit.

FIG. 9 is a diagram illustrating an example configuration of a computer that functions as a learning apparatus and an estimation apparatus.

### DESCRIPTION OF EMBODIMENTS

The following is a description of embodiments of the present invention. Note that, in the drawings to be used in the description below, components having the same functions or steps for performing the same processing will be denoted by the same reference numerals/signs, and explanation of them will not be repeated. In the following description, processing to be performed for each element of a vector or a matrix is applied to all elements of the vector or the matrix, unless otherwise specified.

### First Embodiment

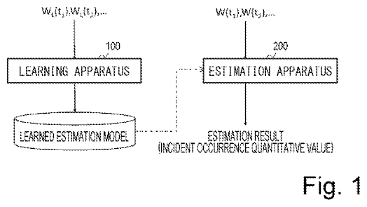

FIG. 1 illustrates an example configuration of an estimation system according to a first embodiment. The estimation system of this embodiment includes a learning apparatus 100 and an estimation apparatus 200. The learning apparatus 100 learns an estimation model using, as inputs, learning psychological-state/sensibility expressing words W_{L}(t₁), W_{L}(t₂) . . . emitted in the region as the target (hereinafter also referred to as the “target region”), and learning incident occurrence quantitative values q_{L}(t₁), q_{L}(t₂), . . . in the target region acquired in association with the respective psychological-state/sensibility expressing words W_{L}(t₁), W_{L}(t₂), . . . , and outputs the learned estimation model. Prior to estimation, the estimation apparatus 200 receives the learned estimation model outputted from the learning apparatus 100. The estimation apparatus 200 receives an input of a time series W(t₁), W(t₂), . . . of the psychological-state/sensibility expressing words emitted in the target region, estimates future incident occurrence quantitative values of the target region from the estimation model, and outputs the estimation results. Note that t₁, t₂, . . . are indexes indicating the input order. For example, W(tᵢ) means the ith inputted psychological-state/sensibility expressing word.

In this embodiment, a person is regarded as a sensor, and future incident occurrence quantitative values are estimated from psychological-state/sensibility expressing words emitted by the person, instead of values outputted from a sensor. A person is regarded as a sensor, because a person has various senses such as the five senses, and perceives various surrounding situations and changes thereof consciously or unconsciously. Here, a psychological-state/sensibility expressing word indicates a psychological state that is difficult to express logically or physically, and is an intuitive or sensitive expression. Therefore, it is considered that a psychological-state/sensibility expressing word emitted at a certain point of time may include information related to the situations of the surroundings consciously or unconsciously perceived at that point of time. Activities of a person and interactions between persons change with time while being related to the past states, an incident is caused by an activity of a person or an interaction between persons, the surroundings of each person change with time while being related to the past states and being affected by activities of a person and interactions between persons, and a psychological-state/sensibility expressing word emitted by each person at a certain point of time may include information related to the situations of the surroundings of each person at that point of time. Therefore, this embodiment uses the relations among these aspects in the target region, to estimate incident occurrence quantitative values after a certain time, from a time series of psychological-state/sensibility expressing words inputted before that time.

The learning apparatus and the estimation apparatus are special apparatuses configured by loading a special program into a known or dedicated computer including a central processing unit (CPU), a main memory (random access memory (RAM)), and the like, for example. The learning apparatus and the estimation apparatus perform each process under the control of the central processing unit, for example. Data inputted to the learning apparatus and the estimation apparatus and data obtained in each process are stored in the main memory, for example. The data stored in the main memory is read into the central processing unit, and is used for other processes as necessary. At least one of the processing units in the learning apparatus and the estimation apparatus may be formed with hardware such as an integrated circuit. Each storage unit included in the learning apparatus and the estimation apparatus can be formed with the main memory such as a random access memory (RAM) or middleware such as a relational database or a key-value store, for example. However, each storage unit is not necessarily included in the learning apparatus or the estimation apparatus. Each storage unit may be formed with an auxiliary memory including a semiconductor memory element such as a hard disk, an optical disk, or a flash memory, and be provided outside the learning apparatus and the estimation apparatus.

First, the learning apparatus is described.

<Learning Apparatus 100>

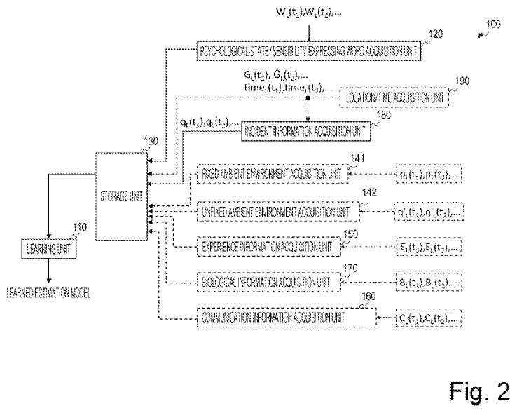

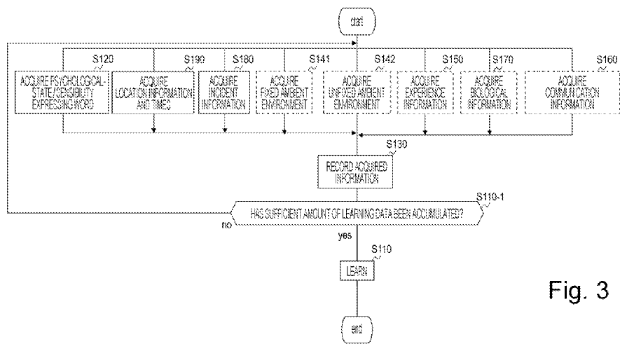

FIG. 2 is a functional block diagram of the learning apparatus 100 according to the first embodiment, and FIG. 3 shows a processing flow thereof. The learning apparatus 100 includes a learning unit 110, a psychological-state/sensibility expressing word acquisition unit 120, a location/time acquisition unit 190, an incident information acquisition unit 180, and a storage unit 130, for example.

<Psychological-State/Sensibility Expressing Word Acquisition Unit 120 and Location/Time Acquisition Unit 190>

The psychological-state/sensibility expressing word acquisition unit 120 and the location/time acquisition unit 190 are provided in a mobile terminal, a tablet terminal, or the like (hereinafter also referred to as a “user terminal”) to be used by the user (the person to acquire learning data), for example. The psychological-state/sensibility expressing word acquisition unit 120 receives, from the user, inputs of character strings of onomatopoeia (learning psychological-state/sensibility expressing words) W_{L}(t₁), W_{L}(t₂), . . . expressing the states of the user at the times of the inputs (S120), and outputs the character strings to the storage unit 130. The location/time acquisition unit 190 acquires location information G_{L}(t₁), G_{L}(t₂), . . . , and times time_{L}(t₁), time_{L}(t₂), . . . at the times when the respective inputs of the learning psychological-state/sensibility expressing words W_{L}(t₁), W_{L}(t₂), . . . were received by the psychological-state/sensibility expressing word acquisition unit 120 (S190), and outputs at least the location information G_{L}(t₁), G_{L}(t₂), . . . to the storage unit 130, and combinations (G_{L}(t₁), time_{L}(t₁)), (G_{L}(t₂), time_{L}(t₂)), . . . of the location information and the times to the incident information acquisition unit 180.

The psychological-state/sensibility expressing word acquisition unit 120 displays an input field for onomatopoeia character strings on the display of the user terminal, for example, and receives inputs of the character strings of onomatopoeia from the user via an input unit such as a touch panel. Note that the input field may be designed to display character strings of a predetermined type of onomatopoeia from which the user is to select, or may be designed to allow the user to input a desired character string. The timing of inputting a character string of onomatopoeia for learning may be every predetermined time or any desired timing. For example, a display unit such as a touch panel may display a message prompting the user to input a character string of onomatopoeia every predetermined time, and may receive the character string of onomatopoeia inputted by the user in response to the message. Alternatively, an application that accepts inputs of character strings of onomatopoeia may be prepared in the user terminal, the user may open the application at any timing, and the application may accept the character string of onomatopoeia inputted by the user, for example.

The location/time acquisition unit 190 includes a functional unit that acquires location information about the user terminal using GPS, for example, and a functional unit that acquires the time from a built-in clock or an NTP server provided in the user terminal, for example. The location/time acquisition unit 190 acquires the location information and the times, when the psychological-state/sensibility expressing word acquisition unit 120 receives inputs of the respective learning psychological-state/sensibility expressing words.

<Incident Information Acquisition Unit 180>

The incident information acquisition unit 180 includes a location/time storage unit, and an information collection unit connected to the Internet, for example. The location/time storage unit of the incident information acquisition unit 180 stores the combinations (G_{L}(t₁), time_{L}(t₁)), (G_{L}(t₂), time_{L}(t₂)), . . . of the location information and the times inputted from the location/time acquisition unit 190. The information collection unit of the incident information acquisition unit 180 acquires, for each of the combinations of the location information and the times stored in the location/time storage unit, incident occurrence quantitative values such as the number of crimes and the number of traffic accidents corresponding to the location information and the times included in the combinations, from a website of the police or the like, for example, and outputs the acquired respective learning incident occurrence quantitative values q_{L}(t₁), q_{L}(t₂), . . . to the storage unit 130 (S180). On a website of the police or the like, incident occurrence quantitative values such as the number of crimes and the number of traffic accidents in each region (each local government, for example) and each time slot are posted at a predetermined timing such as the next day. Therefore, the information collection unit of the incident information acquisition unit 180 reads the respective combinations of the location information and the times from the location/time storage unit after a predetermined timing at which the incident occurrence quantitative values corresponding to the respective combinations of the location information and the times are posted on the website, and acquires the incident occurrence quantitative values for the region including the location information included in the combinations and the time slots including the times included in the combinations. By performing the above operation, the incident information acquisition unit 180 can acquire the respective learning incident occurrence quantitative values at the times of reception of the respective psychological-state/sensibility expressing words in the region including the respective locations where the respective psychological-state/sensibility expressing words were received. Note that the target region is only required to be a range in which incident occurrence quantitative values can be acquired or a range in which incident occurrence quantitative values can be calculated or estimated from the acquired incident occurrence quantitative values, and may be a prefecture, a municipality, an area within a radius of several kilometers from a certain place, a country, the whole world, or the like, for example. The combinations of the location information and the times outputted by the information collection unit of the incident information acquisition unit 180 having acquiring incident occurrence quantitative values may be deleted from the stored contents in the location/time storage unit of the incident information acquisition unit 180.

The information collection unit of the incident information acquisition unit 180 may acquire a plurality of kinds of incident occurrence quantitative values. For example, in a case where two kinds of incident occurrence quantitative values are acquired, incident occurrence quantitative values q1_{L}(t₁), q1_{L}(t₂), . . . of a first kind, and incident occurrence quantitative values q2_{L}(t₁), q2_{L}(t₂), . . . of a second kind are acquired, and are then outputted to the storage unit 130. Note that, in the description below, the incident occurrence quantitative values are q_{L}(t₁), q_{L}(t₂), . . . , for ease of explanation.

<Storage Unit 130>

The storage unit 130 associates the respective learning psychological-state/sensibility expressing words W_{L}(t₁), W_{L}(t₂), . . . with the respective learning incident occurrence quantitative values q_{L}(t₁), q_{L}(t₂), . . . at the times when the respective psychological-state/sensibility expressing words W_{L}(t₁), W_{L}(t₂), . . . were received, classifies the respective sets (W_{L}(t₁), q_{L}(t₁)), (W_{L}(t₂), q_{L}(t₂)), . . . of the psychological-state/sensibility expressing words and the incident occurrence quantitative values obtained by the association for each target region on the basis of the respective pieces of the location information G_{L}(t₁), G_{L}(t₂), . . . at the times when the respective psychological-state/sensibility expressing words W_{L}(t₁), W_{L}(t₂), . . . were received, and stores the sets as learning data of the respective target regions, or stores the sets into the storage unit 130 (S130).

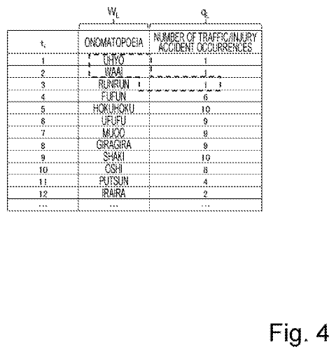

FIG. 4 illustrates an example of learning data of a certain target region stored in the storage unit 130. Note that the storage unit 130 stores the learning data of the respective target regions in the order of inputs of the psychological-state/sensibility expressing words from the user (which is the time order of inputs performed by the user). In other words, the learning data of the respective target regions is stored into the storage unit 130 in the order in which the psychological-state/sensibility expressing word acquisition unit 120 has received the psychological-state/sensibility expressing words. Note that the storage unit 130 may store indexes tᵢ representing the order of inputs from the user (the order of reception by the psychological-state/sensibility expressing word acquisition unit 120) in addition to the psychological-state/sensibility expressing words and the incident occurrence quantitative values. In this case, the indexes tᵢ are added so that i increases by 1 at a time in the learning data of the respective target regions, and the respective sets (t₁, W_{L}(t₁), q_{L}(t₁)), (t₂, W_{L}(t₂), q_{L}(t₂)), . . . of the indexes, the psychological-state/sensibility expressing words, and the incident occurrence quantitative values are stored as the learning data of the respective target regions. In the example in FIG. 4, the indexes tᵢ indicating the order of inputs of the psychological-state/sensibility expressing words from the user (the order of reception by the psychological-state/sensibility expressing word acquisition unit 120) is stored as well, but the storage unit 130 does not need to store the indexes tᵢ in a case where the order of inputs from the user (the order of reception by the psychological-state/sensibility expressing word acquisition unit 120) is known from the stored layout or the like. Note that FIG. 4 is an example of learning data of a certain target region in which the indexes t₁, the character strings W_{L}(tᵢ) of onomatopoeia acquired about every 2 hours, and the traffic/injury accident occurrence numbers q_{L}(tᵢ) in the time slots including the times when the respective onomatopoeic words were acquired are associated with each other and are stored in the storage unit 130.

<Location/Time Acquisition Unit 190 and Incident Information Acquisition Unit 180 in a Case where there is No Need to Use Location Information>

In a case where it is known that the user is in the target region, the learning apparatus 100 does not need to use the location information. In a case where it is known that the user is in the target region, such as a case where the user is always in Japan when the incident occurrence quantitative values for the entire area of Japan as the target region are set as the targets, or a case where the incident occurrence quantitative values for the entire world are set as the targets, or the like, the location/time acquisition unit 190 needs to neither acquire nor output the location information, but acquires only the times time_{L}(t₁), time_{L}(t₂), . . . when the learning psychological-state/sensibility expressing words W_{L}(t₁), W_{L}(t₂), . . . were received by the psychological-state/sensibility expressing word acquisition unit 120, and outputs the times to the incident information acquisition unit 180. In this case, the location/time storage unit of the incident information acquisition unit 180 stores only the times time_{L}(t₁), time_{L}(t₂), . . . inputted from the location/time acquisition unit 190, and the information collection unit of the incident information acquisition unit 180 acquires and outputs the incident occurrence quantitative values for the known target region and for the respective times stored in the location/time storage unit, to the storage unit 130. In this case, it is safe to say that the location/time acquisition unit 190 is a time acquisition unit, and the location/time storage unit is a time storage unit.

<Location/Time Acquisition Unit 190 and Incident Information Acquisition Unit 180 in a Case where there is No Need to Use Times>

If a sensor network including sensors such as a large number of cameras is constructed, and an information processing system that aggregates and counts information that is combinations of incidents and the locations where the incidents occurred as obtained by the sensor network is constructed, for example, there is a possibility that the incident occurrence quantitative values can be obtained from the information processing system substantially in real time, depending on the incident occurrence quantitative values. In this case, the location/time acquisition unit 190 does not need to neither acquire nor output times, but needs to output only the location information G_{L}(t₁), G_{L}(t₂), . . . at the times when the respective learning psychological-state/sensibility expressing words W_{L}(t₁), W_{L}(t₂), . . . were received by the psychological-state/sensibility expressing word acquisition unit 120, to the incident information acquisition unit 180. In this case, the information collection unit of the incident information acquisition unit 180 acquires only the incident occurrence quantitative values for the respective pieces of the location information from the information processing system including the sensor network described above, and outputs the incident occurrence quantitative values to the storage unit 130. In this case, the incident information acquisition unit 180 does not need to include the location/time storage unit. Also, in this case, it is safe to say that the location/time acquisition unit 190 is a location acquisition unit. Note that, in a case where it is known that the user is in the target region in this case, the learning apparatus 100 needs to acquire neither the location information nor the times, and therefore, does not need to include the location/time acquisition unit 190.

<Learning Unit 110>

When a sufficient amount of the learning psychological-state/sensibility expressing words to learn the estimation model for the target region and the learning incident occurrence quantitative values corresponding to the words are accumulated in the storage unit 130 (S110-1), the learning unit 110 extracts, for the target region, the learning psychological-state/sensibility expressing words and the learning incident occurrence quantitative values corresponding to the words from the storage unit 130, learns the estimation model (S110), and outputs the learned estimation model. That is, the estimation model is a model that estimates incident occurrence quantitative values after the time time(t) in the target region, with the inputs being two or more psychological-state/sensibility expressing words in time order till the time time(t), these words having been emitted in the target region. Note that the time time(t) represents the time when the t-th psychological-state/sensibility expressing word is inputted. In this embodiment, although the input times (the reception times) are not acquired, but the input order (reception order) is identified. Accordingly, it is possible to determine whether a psychological-state/sensibility expressing word is a psychological-state/sensibility expressing word inputted before the time time(t) at which the t-th psychological-state/sensibility expressing word was input, and whether an incident occurrence quantitative value is an incident occurrence quantitative value after the time time(t).

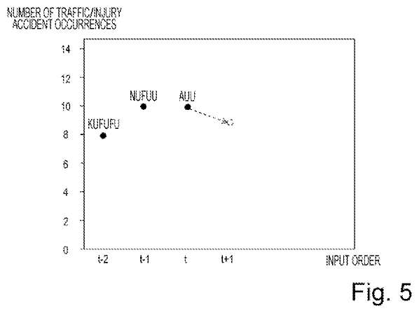

For example, in a case illustrated in FIG. 5, the estimation model is a model that estimates the (t+1)th incident occurrence quantitative value q(t+1), with the inputs being the (t−1)th psychological-state/sensibility expressing word W(t−1) “nufuu” and the t-th psychological-state/sensibility expressing word W(t) “Auu”. Therefore, the learning apparatus 100 sets a combination of two or more psychological-state/sensibility expressing words in time order till the time time(t) and learning incident occurrence quantitative values indicating the incident occurrence quantitative values after the time time(t) as one set of learning data (the portion surrounded by a dashed line in FIG. 4), and learns the estimation model, using a large amount of learning data.

Note that the estimation model of this embodiment is an estimation model for the target region, and is to estimate the incident occurrence quantitative values after the time time(t) in the target region, with the inputs being two or more psychological-state/sensibility expressing words in time order emitted by a certain subject person in the target region till the time time(t). The learning data that is used for learning the estimation model may be acquired from one user, or may be acquired from a plurality of users. In a case where the psychological-state/sensibility expressing word acquisition unit 120 acquires psychological-state/sensibility expressing words from a plurality of users, the psychological-state/sensibility expressing words acquired from the respective users are stored together with the identifiers of the respective users in the storage unit 130, and, at the time of learning, the learning unit 110 performs learning using the time series of the psychological-state/sensibility expressing words of the respective users and the incident occurrence quantitative values. When the learning unit 110 performs this learning on an unspecified large number of users, it is possible to obtain an estimation model capable of coping with an unspecified large number of subject persons (hereinafter, this estimation model will be also referred to as the “first estimation model”). That is, with this first estimation model, it is possible to estimate the incident occurrence quantitative values after the time time(t) not depending on subject persons, with the inputs being two or more psychological-state/sensibility expressing words in time order emitted by a certain subject person till the time time(t). Note that “emitting” a psychological-state/sensibility expressing word means presenting a psychological-state/sensibility expressing word to the outside by some means, and is a concept including “inputting” a psychological-state/sensibility expressing word via an input unit such as a touch panel, “uttering” a psychological-state/sensibility expressing word, and the like. Note that the processing in the case of “uttering” a psychological-state/sensibility expressing word will be described later.

Further, the subject person who is the estimation target of the estimation apparatus 200 may be a new user (a subject person to acquire learning data), the first estimation model may be relearned through the learning data acquired from the new user, and the relearned estimation model may be outputted as an estimation model to be used in the estimation apparatus 200. With such a configuration, it is possible to acquire a sufficient amount of learning data, and learn an estimation model having a low degree of dependence on the subject person who emits the psychological-state/sensibility expressing words to be used for estimation.

(Example 1 of an Estimation Model)

A model (a table or a list) in which two or more onomatopoeic words (character strings) in time order till a certain time are associated with incident occurrence quantitative values after the certain time is used as the estimation model.

(Example 2 of an Estimation Model)

In this example, the estimation model is a model learned by machine learning such as a neural network, on the basis of two or more learning onomatopoeic words in time order till a certain time and learning incident occurrence quantitative values after the certain time. For example, a neural network that receives inputs of two or more onomatopoeic words (character strings) in time order till a certain time, and outputs incident occurrence quantitative values after the certain time is used as the estimation model. In this case, the parameters of the neural network are repeatedly updated so that the results of estimation of the incident occurrence quantitative values obtained by inputting two or more onomatopoeic words (character strings) in time order till a certain time in the learning data to the neural network having an appropriate initial value set in advance approaches the incident occurrence quantitative values after the certain time in the learning data. In this manner, the estimation model is learned. Note that, in a case where learning data in which a plurality of incident occurrence quantitative values is associated with one onomatopoeic word is used, an output of the estimation model may be learned as a list (a set) of a plurality of incident occurrence quantitative values.

Next, the estimation apparatus is described.

<Estimation Apparatus 200>

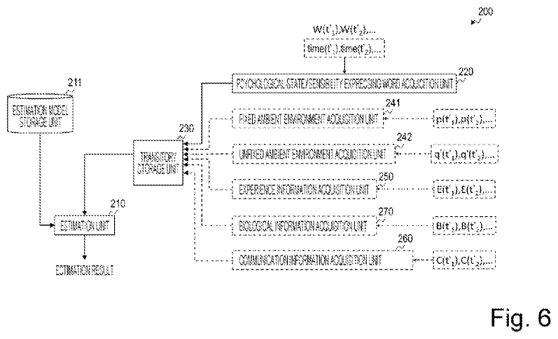

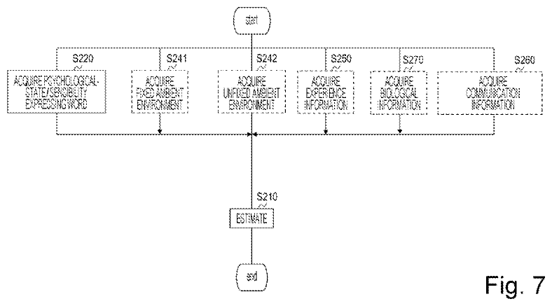

FIG. 6 is a functional block diagram of the estimation apparatus 200 according to the first embodiment, and FIG. 7 shows a processing flow thereof. The estimation apparatus 200 includes an estimation unit 210, an estimation model storage unit 211, a psychological-state/sensibility expressing word acquisition unit 220, and a transitory storage unit 230.

<Psychological-State/Sensibility Expressing Word Acquisition Unit 220 and Transitory Storage Unit 230>

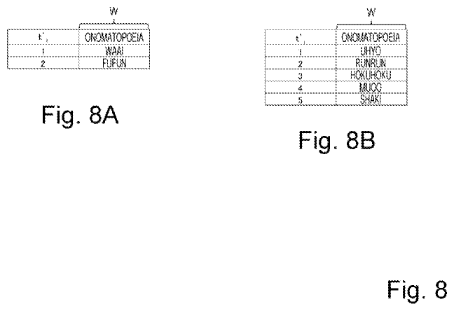

The psychological-state/sensibility expressing word acquisition unit 220 receives inputs of character strings of onomatopoeia (psychological-state/sensibility expressing words) W(t′₁), W(t′₂), . . . that express the states of the subject person at a plurality of times time(t′₁), time(t′₂), . . . in the target region from the user of the estimation apparatus 200 (S220), and stores the character strings into the transitory storage unit 230. Note that the user of the estimation apparatus 200 (the person who obtains the results of estimation of incident occurrence quantitative values) and the subject person (the person who inputs psychological-state/sensibility expressing words to estimate incident occurrence quantitative values) may be the same person, or may be different persons. The transitory storage unit 230 stores psychological-state/sensibility expressing words, and FIG. 8 shows an example of the data stored in the transitory storage unit 230. FIG. 8A is an example in a case where inputs of psychological-state/sensibility expressing words W(t′₁) and W(t′₂) at two times have been received. FIG. 8B is an example in a case where inputs of psychological-state/sensibility expressing words W(t′₁), . . . , and W(t′₅) at five times have been received. Note that the data is stored in the order of inputs from the user, which is the order of reception of the inputs at the psychological-state/sensibility expressing word acquisition unit 220. Note that, in the examples in FIG. 8, the indexes t′ᵢ indicating the order of inputs (the order of reception) are stored as well, but the indexes t′ᵢ may not be stored in a case where the order of inputs (the order of reception) is apparent from the stored layout or the like.

Like the psychological-state/sensibility expressing word acquisition unit 120 of the learning apparatus 100, the psychological-state/sensibility expressing word acquisition unit 220 receives inputs of psychological-state/sensibility expressing words from the subject person in relation to a mobile terminal, a tablet terminal, or the like (hereinafter also referred to as a “subject person terminal”) being used by the subject person. To prevent psychological-state/sensibility expressing words emitted outside the target region from being included in the psychological-state/sensibility expressing words at the plurality of times to be used for estimation, the psychological-state/sensibility expressing word acquisition unit 220 is designed not to store any psychological-state/sensibility expressing word emitted outside the target region into the transitory storage unit 230, or not to receive any input of a psychological-state/sensibility expressing word outside the target region. The psychological-state/sensibility expressing word acquisition unit 220 acquires the location information through a functional unit that acquires the location information about the subject person terminal using GPS, for example, and determines whether the subject person terminal is outside the target region, using the acquired location information.

<Estimation Unit 210 and Estimation Model Storage Unit 211>

The learned estimation model for the target region outputted by the learning apparatus 100 is stored beforehand into the estimation model storage unit 211. The estimation unit 210 extracts two or more psychological-state/sensibility expressing words emitted in the target region from the transitory storage unit 230, estimates future incident occurrence quantitative values of the target region from the two or more psychological-state/sensibility expressing words emitted by the subject person in the target region and the order of inputs (the order of reception) thereof, using the learned estimation model stored beforehand in the estimation model storage unit 211 (S210), and outputs the estimation results. Note that the estimation unit 210 is only required to extract, from the transitory storage unit 230, the psychological-state/sensibility expressing words necessary for estimating future incident occurrence quantitative values in the estimation model, and the necessary psychological-state/sensibility expressing words are specified by the learning method in the estimation model.

Also, the estimation unit 210 may be designed to use a necessary estimation model, depending on which incident occurrence quantitative values are to be estimated. For example, (i) a learned estimation model for estimating the “number of crimes”, (ii) a learned estimation model for estimating the “number of traffic accidents”, (iii) a learned estimation model for estimating both the “number of crimes” and the “number of traffic accidents”, and the like may be prepared in the estimation model storage unit 211, and the estimation unit 210 may select the necessary estimation model in accordance with the purpose. Also, the estimation unit 210 may be designed to use a necessary estimation model, depending on the region from which incident occurrence quantitative values are to be estimated. For example, (i) a learned estimation model for estimating the “number of crimes” in Tokyo, (ii) a learned estimation model for estimating the “number of crimes” in Kanagawa Prefecture, (iii) a learned estimation model for estimating the “number of crimes” throughout Japan, and the like may be prepared in the estimation model storage unit 211, and the estimation unit 210 may select the necessary estimation model in accordance with the purpose.

Note that the estimation apparatus 200 is only required to estimate incident occurrence quantitative values after a time time(t′), with the inputs being two or more psychological-state/sensibility expressing words in time order till the time time(t′). The estimation model that is learned by the learning apparatus 100 and is stored in the estimation model storage unit 211 of the estimation apparatus 200 is only required to be a model that estimates incident occurrence quantitative values after the time time(t′), with the inputs being the two or more psychological-state/sensibility expressing words in time order till the time time(t′). For example, the number of the psychological-state/sensibility expressing words in time order till the time time(t′) to be used by the estimation apparatus 200 is not necessarily two, but may be two or more, and further, the order of emission by the subject person is not necessarily continuous. Likewise, the number of the psychological-state/sensibility expressing words in time order till a time time_{L}(t) to be used by the learning apparatus 100 is not necessarily two, but may be two or more, and further, the order of emission by the user is not necessarily continuous. For example, the estimation apparatus 200 may estimate incident occurrence quantitative values after the time time(t′), using the t′−3rd, t′−1st, and t′−th psychological-state/sensibility expressing words. In this case, the estimation model that is learned by the learning apparatus 100 is only required to be a model that estimates incident occurrence quantitative values after the time time(t), using the t−3rd, t−1st, and t-th psychological-state/sensibility expressing words. Also, the incident occurrence quantitative values to be estimated by the estimation apparatus 200 are only required to be the incident occurrence quantitative values after the time time(t′) corresponding to the t′-th psychological-state/sensibility expressing word. For example, the estimation model that is learned by the learning apparatus 100 may be a model that estimates the incident occurrence quantitative values corresponding to the (t+2)th and later psychological-state/sensibility expressing words. Also, the estimation apparatus 200 may estimate two or more incident occurrence quantitative values after the time time(t′). In this case, the estimation model that is learned by the learning apparatus 100 may be a model that estimates two or more incident occurrence quantitative values after the time time(t). For example, the estimation apparatus 200 may estimate the (t′+1)th and (t′+2)th incident occurrence quantitative values, using the (t′−1)th and t′-th psychological-state/sensibility expressing words. In this case, the estimation model that is learned by the learning apparatus 100 may be a model that estimates the (t+1)th and (t+2)th incident occurrence quantitative values, using the (t−1)th and t′-th psychological-state/sensibility expressing words. These estimation models are achievable depending on learning, and inputs and outputs for each estimation model should be set, with the purpose of use, the cost, and the estimation accuracy of the estimation apparatus 200 being taken into consideration.

<Effects>

With such a configuration, future incident occurrence quantitative values can be estimated, on the basis of the psychological-state/sensibility expressing words till the present.

<Modification 1: Time>

Differences from the first embodiment is now mainly described.

Activities of a person and interactions between persons change with time while being related to the past states, an incident is caused by an activity of a person or an interaction between persons, the surroundings of each person change with time while being related to the past states and being affected by activities of a person and interactions between persons, and a psychological-state/sensibility expressing word emitted by each person at a certain point of time may include information related to the situations of the surroundings of each person at that point of time. Therefore, this modification uses the relations among these aspects, to estimate an incident occurrence quantitative value at a certain time later than another certain time, from a time series of psychological-state/sensibility expressing words inputted together with time information till the other certain time. In this modification, an estimation model is learned, with the inputs being the times corresponding to two or more psychological-state/sensibility expressing words. With the use of the estimation model obtained through the learning, future incident occurrence quantitative values are estimated, with the inputs being the times corresponding to two or more psychological-state/sensibility expressing words.

<Psychological-State/Sensibility Expressing Word Acquisition Unit 120>

The psychological-state/sensibility expressing word acquisition unit 120 is the same as that of the first embodiment. That is, the psychological-state/sensibility expressing word acquisition unit 120 receives, from the user, inputs of character strings of onomatopoeia (learning psychological-state/sensibility expressing words) W_{L}(t₁), W_{L}(t₂), . . . expressing the states of the user at the times of the inputs (S120), and outputs the character strings to the storage unit 130.

<Location/Time Acquisition Unit 190>

The location/time acquisition unit 190 is the same as that of the first embodiment, except for also outputting times to the storage unit 130. That is, the location/time acquisition unit 190 acquires location information G_{L}(t₁), G_{L}(t₂), . . . , and times time_{L}(t₁), time_{L}(t₂), . . . at the times when the respective inputs of the learning psychological-state/sensibility expressing words W_{L}(t₁), W_{L}(t₂), . . . were received by the psychological-state/sensibility expressing word acquisition unit 120 (S190), and outputs combinations (G_{L}(t₁), time_{L}(t₁)), (G_{L}(t₂), time_{L}(t₂)), . . . of the location information and the times to the storage unit 130 and the incident information acquisition unit 180.

<Incident Information Acquisition Unit 180>

The incident information acquisition unit 180 is the same as that of the first embodiment. That is, the incident information acquisition unit 180 acquires the incident occurrence quantitative values corresponding to the location information and the times included in the respective combinations (G_{L}(t₁), time_{L}(t₁)), (G_{L}(t₂), time_{L}(t₂)), . . . of the location information and the times stored in the location/time storage unit, and outputs the respective acquired learning incident occurrence quantitative values q_{L}(t₁), q_{L}(t₂), . . . to the storage unit 130 (S180).

<Storage Unit 130>

The storage unit 130 associates the respective learning psychological-state/sensibility expressing words W_{L}(t₁), W_{L}(t₂), . . . with the respective learning incident occurrence quantitative values q_{L}(t₁), q_{L}(t₂), . . . at the times when the respective psychological-state/sensibility expressing words W_{L}(t₁), W_{L}(t₂), . . . were received, and the times time_{L}(t₁), time_{L}(t₂), . . . at which the respective psychological-state/sensibility expressing words W_{L}(t₁), W_{L}(t₂), . . . were received. The storage unit 130 then classifies, for each target region, the combinations (W_{L}(t₁), q_{L}(t₁), time_{L}(t₁)), (W_{L}(t₂), q_{L}(t₂), time_{L}(t₂)), . . . of the psychological-state/sensibility expressing words, the incident occurrence quantitative values, and the times obtained by the association, on the basis of the respective pieces of the location information G_{L}(t₁), G_{L}(t₂), . . . at the times of reception of the respective psychological-state/sensibility expressing words W_{L}(t₁), W_{L}(t₂), . . . , and stores the classified combinations as the learning data of the respective target regions, or stores the classified combinations into the storage unit 130 (S130). Note that, since the order of inputs is apparent from the corresponding times, there is no need to store the indexes tᵢ indicating the order of inputs into the storage unit 130. However, the indexes tᵢ indicating the order of inputs may be stored into the storage unit 130.

<Learning Unit 110>

When a sufficient amount of the learning psychological-state/sensibility expressing words to learn the estimation model for the target region, the learning incident occurrence quantitative values corresponding to the words, and the corresponding times are accumulated in the storage unit 130 (S110-1), the learning unit 110 of the learning apparatus 100 extracts, for the target region, the learning psychological-state/sensibility expressing words, the times corresponding to the learning psychological-state/sensibility expressing words, and the corresponding learning incident occurrence quantitative values from the storage unit 130, learns the estimation model (S110), and outputs the learned estimation model. Note that the estimation model may be learned, using the corresponding times time_{L}(t₁), time_{L}(t₂), . . . without any change to them. Also, elapsed times ([time_{L}(t₂)−time_{L}(t₁)], [time_{L}(t₃)−time_{L}(t₂)], . . . , for example) since the emission of the previous psychological-state/sensibility expressing words may be calculated from the times time_{L}(t₁), time_{L}(t₂), . . . , and an estimation model may be learned with the use of the elapsed times since the inputs of the previous psychological-state/sensibility expressing words.

(Example 1 of Learning of an Estimation Model)

For example, the learning apparatus 100 uses a combination of two or more psychological-state/sensibility expressing words W_{L}(t), W_{L}(t−1), . . . till a certain time time_{L}(t), the corresponding times time_{L}(t), time_{L}(t−1), . . . or the differences [time_{L}(t)−time_{L}(t−1)], . . . between those times, and an incident occurrence quantitative value q_{L}(t+1) after the time time_{L}(t) as one set of learning data, and learns an estimation model using a large amount of learning data. The estimation model in Example 1 of learning according to this modification is a model to be used when the estimation apparatus 200 estimates incident occurrence quantitative values after the time time(t′), with the inputs being two or more psychological-state/sensibility expressing words in time order till the time time(t′), and the times corresponding to the psychological-state/sensibility expressing words or the time difference between those times.

(Example 2 of Learning of an Estimation Model)

For example, the learning apparatus 100 also uses a combination of two or more psychological-state/sensibility expressing words W_{L}(t), W_{L}(t−1), . . . till a certain time time_{L}(t), the order of inputs (order of reception) t, t−1, . . . , the time intervals |time_{L}(t)−time_{L}(t−1)|, . . . , and an incident occurrence quantitative value q_{L}(t+1) after the time time_{L}(t) as one set of learning data, and learns an estimation model using a large amount of learning data. The estimation model in Example 2 of learning according to this modification is a model to be used when the estimation apparatus 200 estimates incident occurrence quantitative values after the time time(t′), with the inputs being two or more psychological-state/sensibility expressing words in time order till the time time(t′), the order of inputs (the order of reception) of those psychological-state/sensibility expressing words, and the intervals (time intervals) between the times corresponding to those psychological-state/sensibility expressing words.

<Psychological-State/Sensibility Expressing Word Acquisition Unit 220 and Transitory Storage Unit 230>

The psychological-state/sensibility expressing word acquisition unit 220 of the estimation apparatus 200 receives inputs of character strings of onomatopoeia (psychological-state/sensibility expressing words) W(t′₁), W(t′₂), . . . expressing the states of the subject person at a plurality of times in the region as the target (S220), acquires the corresponding times time(t′₁), time(t′₂), . . . , and stores these combinations into the transitory storage unit 230. Accordingly, the transitory storage unit 230 stores the psychological-state/sensibility expressing words W(t′₁), W(t′₂), . . . , and the corresponding times time(t′₁), time (t′₂), . . . . Note that, since the order of inputs (the order of reception) is apparent from the corresponding times, there is no need to store the indexes t′ᵢ indicating the order of inputs (the order of reception) into the transitory storage unit 230. However, the indexes t′ᵢ indicating the order of inputs may be stored into the transitory storage unit 230. Note that the design in which the psychological-state/sensibility expressing word acquisition unit 220 acquires times is the same as that of the location/time acquisition unit 190.

<Estimation Unit 210 and Estimation Model Storage Unit 211>

The learned estimation model for the target region outputted by the learning apparatus 100 of this modification is stored beforehand into the estimation model storage unit 211. The estimation unit 210 of the estimation apparatus 200 extracts, from the transitory storage unit 230, two or more psychological-state/sensibility expressing words and the times corresponding to the psychological-state/sensibility expressing words.

(Example Estimation in a Case where the Estimation Model of Example 1 of Learning)

In a case where the estimation model of Example 1 of learning according to this modification, the estimation unit 210 of the estimation apparatus 200 calculates a time difference from the corresponding times as necessary, estimates future incident occurrence quantitative values in the target region from two or more psychological-state/sensibility expressing words emitted by the subject person in the target region and the times corresponding to the respective psychological-state/sensibility expressing words or the time difference between those times, using the learned estimation model of Example 1 of learning for the target region, the learned estimation model being stored beforehand in the estimation model storage unit 211 (S210), and outputs the estimation results.

(Example Estimation in a Case where the Estimation Model of Example 2 of Learning)

In a case where the estimation model of Example 2 of learning according to this modification, the estimation unit 210 of the estimation apparatus 200 calculates the order of inputs (the order of reception) and a time difference from the corresponding times, estimates future incident occurrence quantitative values in the target region from two or more psychological-state/sensibility expressing words emitted by the subject person in the target region, the order of inputs (the order of reception) of the respective psychological-state/sensibility expressing words, and the time interval between the times corresponding to the respective psychological-state/sensibility expressing words, using the learned estimation model of Example 2 of learning for the target region, the learned estimation model being stored beforehand in the estimation model storage unit 211 (S210), and outputs the estimation results. Note that, in a case where the indexes t′ᵢ indicating the order of inputs (the order of reception) are stored in the transitory storage unit 230, the order of inputs (the order of reception) is not calculated from the times, but the indexes t′ᵢ indicating the order of inputs (the order of reception) stored in the transitory storage unit 230 should be used without any change to them.

According to Modification 1, with the configuration described above, the same effects as those of the first embodiment can be achieved. Furthermore, with the times being taken into consideration, incident occurrence quantitative values can be estimated more accurately.

<Modification 2: Plural Persons>

Differences from Modification 1 is now mainly described.

A psychological-state/sensibility expressing word emitted by a person at a point of time includes information related to the surrounding situation of the person at the point of time, and information about the mood of the person at the point of time. An incident is caused by a person's activity or an interaction between persons, and therefore, the occurrence of an incident in a certain region depends on the surrounding situation of each person and the mood of each person among a plurality of persons present in the region. That is, if learning and estimation is performed with the use of psychological-state/sensibility expressing words emitted by a larger number of people present in the same region, learning and estimation with higher relevance to temporal changes of incident occurrence quantitative values would be possible. Therefore, in this modification, incident occurrence quantitative values after the time time(t) in the target region are estimated, with the inputs being psychological-state/sensibility expressing words in time order till the time time(t), these words having been emitted by a plurality of subject persons in the target region. Note that, to further increase the relevance to the temporal changes of incident occurrence quantitative values in the target region, psychological-state/sensibility expressing words of as many people as possible in the target region should be used. Here, “mood” means an emotional state that is expressed as “energetic (with vigor) or not energetic (without vigor)”, “comfortable or uncomfortable”, “tense or relaxed”, “at ease or not at ease”, “positive or negative”, “satisfied or dissatisfied”, “calm or irritated”, joy, sorrow, anger, or the like.

<Psychological-State/Sensibility Expressing Word Acquisition Unit 120 and Location/Time Acquisition Unit 190>

The psychological-state/sensibility expressing word acquisition unit 120 of the learning apparatus 100 receives, from a plurality of users, inputs of character strings of onomatopoeia (learning psychological-state/sensibility expressing words) expressing the states of the users at the times of the inputs (S120), and outputs the character strings to the storage unit 130. The location/time acquisition unit 190 acquires the location information and the times at the times when the psychological-state/sensibility expressing word acquisition unit 120 received the inputs of the respective learning psychological-state/sensibility expressing words (S190), and outputs the sets of the location information and the times to the storage unit 130 and the incident information acquisition unit 180. The times to be acquired by the location/time acquisition unit 190 preferably have smaller differences between the users, and therefore, are acquired from an NTP server or the like.

<Incident Information Acquisition Unit 180>

The incident information acquisition unit 180 is the same as that of Modification 1. That is, the incident information acquisition unit 180 acquires the incident occurrence quantitative values corresponding to the location information and the times included in the respective combinations of the location information and the times stored in the location/time storage unit, and outputs the respective acquired learning incident occurrence quantitative values to the storage unit 130 (S180). As a result, the incident information acquisition unit 180 can acquire and output the respective learning incident occurrence quantitative values at the times when the respective psychological-state/sensibility expressing words were received.

<Storage Unit 130>

The storage unit 130 associates the respective learning psychological-state/sensibility expressing words with the respective learning incident occurrence quantitative values at the times when the respective psychological-state/sensibility expressing words were received and the times when the respective psychological-state/sensibility expressing words were received, classifies the respective combinations of the psychological-state/sensibility expressing words, the incident occurrence quantitative values, and the times obtained by the association for each target region on the basis of the respective pieces of the location information at the times when the respective psychological-state/sensibility expressing words were received, and stores the combinations as learning data of the respective target regions, or stores the combinations into the storage unit 130 (S130). The combinations of the psychological-state/sensibility expressing words, the incident occurrence quantitative values, and the times may be stored into the storage unit 130, without the user who performed the input being distinguished from the others. Where the indexes indicating the order of inputs by all users are represented by tᵢ, the combinations of the psychological-state/sensibility expressing words W_{L}(tᵢ), the incident occurrence quantitative values q_{L}(tᵢ), and the times time_{L}(tᵢ) to be stored into the storage unit 130 can be [W_{L}(t₁), q_{L}(t₁), time_{L}(t₁)], [W_{L}(t₂), q_{L}(t₂), time_{L}(t₂)], . . . , for example. Note that there is no need to store the indexes tᵢ indicating the order of inputs into the storage unit 130. However, the indexes tᵢ indicating the order of inputs may be stored into the storage unit 130. In the case of this modification, inputs at the same time might be made by a plurality of users. However, the indexes tᵢ do not have any technical meaning, and therefore, the order of storing the inputs made at the same time into the storage unit 130 can be indicated by the indexes tᵢ.

<Learning Unit 110>

The learning unit 110 is the same as that of Modification 1. That is, when a sufficient amount of the learning psychological-state/sensibility expressing words to learn the estimation model for the target region, the learning incident occurrence quantitative values corresponding to the words, and the corresponding times are accumulated in the storage unit 130 (S110-1), the learning unit 110 of the learning apparatus 100 extracts, for the target region, the learning psychological-state/sensibility expressing words, the times corresponding to the learning psychological-state/sensibility expressing words, and the corresponding learning incident occurrence quantitative values from the storage unit 130, learns the estimation model (S110), and outputs the learned estimation model. Note that the estimation model may be learned, using the corresponding times time_{L}(t₁), time_{L}(t₂), . . . without any change to them. Also, elapsed times ([time_{L}(t₁)−time_{L}(t₀)], [time_{L}(t₂)−time_{L}(t₀)], [time_{L}(t₃)−time_{L}(t₀)], . . . , for example) since a predetermined time time_{L}(t₀) may be calculated from the times time_{L}(t₁), time_{L}(t₂), . . . , and an estimation model may be learned with the use of the elapsed times since the predetermined time.

(Example of Learning of an Estimation Model)

For example, the learning apparatus 100 uses a combination of psychological-state/sensibility expressing words W_{L}(t), W_{L}(t−1), . . . emitted by a plurality of users till a certain time time_{L}(t), the corresponding times time_{L}(t), time_{L}(t−1), . . . or the elapsed times [time_{L}(t)−time_{L}(t₀)], [time_{L}(t−1)−time_{L}(t₀)], . . . since the predetermined time, and an incident occurrence quantitative value q_{L}(t+1) after the time time_{L}(t) as one set of learning data of the target region, and learns an estimation model using a large amount of learning data. The estimation model in the example of learning according to this modification is a model to be used when the estimation apparatus 200 estimates incident occurrence quantitative values after the time time(t′), with the inputs being the psychological-state/sensibility expressing words emitted by a plurality of subject persons in the target region till the time time(t′), and the times corresponding to the respective psychological-state/sensibility expressing words or the elapsed times since a predetermined time.

<Psychological-State/Sensibility Expressing Word Acquisition Unit 220 and Transitory Storage Unit 230>

The psychological-state/sensibility expressing word acquisition unit 220 of the estimation apparatus 200 receives inputs of character strings of onomatopoeia (psychological-state/sensibility expressing words) expressing the states of a plurality of subject persons at a plurality of times in the target region (S220), acquires the corresponding times, . . . , and stores these combinations into the transitory storage unit 230. Accordingly, the transitory storage unit 230 stores the psychological-state/sensibility expressing words W(t′₁), W(t′₂), . . . , and the corresponding times time(t′₁), time (t′₂), . . . . Note that the combinations of the psychological-state/sensibility expressing words and the times may be stored into the transitory storage unit 230, without the subject person who performed the input being distinguished from the others.

<Estimation Unit 210 and Estimation Model Storage Unit 211>

The learned estimation model for the target region outputted by the learning apparatus 100 of this modification is stored beforehand into the estimation model storage unit 211. The estimation unit 210 of the estimation apparatus 200 extracts, from the transitory storage unit 230, a large number of psychological-state/sensibility expressing words emitted in the target region, and the times corresponding to the psychological-state/sensibility expressing words.

(Example Estimation in a Case where the Estimation Model of the Example of Learning)

In a case where the estimation model of the example of learning according to this modification, the estimation unit 210 of the estimation apparatus 200 calculates the elapsed times from a predetermined time as necessary, estimates future incident occurrence quantitative values in the target region from a large number of psychological-state/sensibility expressing words emitted by a large number of subject persons in the target region and the times corresponding to the respective psychological-state/sensibility expressing words or the elapsed times since the predetermined time, using the learned estimation model of the example of learning for the target region, the learned estimation model being stored beforehand in the estimation model storage unit 211 (S210), and outputs the estimation results.

<Modification 3: Time>

Differences from Modification 1 is now mainly described.

In this modification, an estimation model is learned with the use of the times corresponding to incident occurrence quantitative values. The learned estimation model is used in estimating how much later an estimated future incident occurrence quantitative value belongs, or estimating the incident occurrence quantitative value at a designated future time.

<Learning Unit 110>

When a sufficient amount of learning psychological-state/sensibility expressing words to learn the estimation model for the target region, the learning incident occurrence quantitative values corresponding to the words, and the corresponding times are accumulated in the storage unit 130 (S110-1), the learning unit 110 of the learning apparatus 100 extracts, for the target region, the learning psychological-state/sensibility expressing words, the learning incident occurrence quantitative values corresponding to the learning psychological-state/sensibility expressing words, the times corresponding to the learning psychological-state/sensibility expressing words, and the times corresponding to the learning incident occurrence quantitative values from the storage unit 130, learns the estimation model (S110), and outputs the learned estimation model. For example, the learning apparatus 100 uses a combination of two or more psychological-state/sensibility expressing words in time order till a time time_{L}(t), the incident occurrence quantitative value at a time time_{L}(t+1) that is a time later than the time_{L}(t), the time time_{L}(t) and a time time_{L}(t+1) or the difference [time_{L}(t+1)−time_{L}(t)] between those times, as one set of learning data, and learns an estimation model using a large amount of learning data.

Note that the estimation model of this modification is a model to be used when the estimation apparatus 200 estimates incident occurrence quantitative values after a time time(t′) and the times corresponding to the incident occurrence quantitative values, with the inputs being two or more psychological-state/sensibility expressing words in time order till the time time(t′). Alternatively, the estimation model of this modification is a model to be used when the estimation apparatus 200 estimates an incident occurrence quantitative value at a future time, with the inputs being two or more psychological-state/sensibility expressing words in time order till the time time(t′) and the future time.

The learning incident occurrence quantitative value acquired by the incident information acquisition unit 180 are often on a time slot basis. Therefore, the learning unit 110 uses the times corresponding to the learning psychological-state/sensibility expressing words associated with the learning incident occurrence quantitative values, or the median value of the times of the time slots for the learning incident occurrence quantitative values, as the times corresponding to the learning incident occurrence quantitative values.

<Estimation Unit 210 and Estimation Model Storage Unit 211>

The learned estimation model for the target region outputted by the learning apparatus 100 of this modification is stored beforehand into the estimation model storage unit 211. The estimation unit 210 of the estimation apparatus 200 extracts two or more psychological-state/sensibility expressing words W(t′), W(t′−1), . . . emitted in the target region and the corresponding time time(t′) from the transitory storage unit 230, estimates a future incident occurrence quantitative value of the target region and the time corresponding to the incident occurrence quantitative value from the two or more psychological-state/sensibility expressing words emitted by the subject person in the target region, using the learned estimation model stored beforehand in the estimation model storage unit 211 (S210), and outputs the estimation result. That is, how far in the future the incident occurrence quantitative value belongs is output together with the result of estimation of the incident occurrence quantitative value. Alternatively, the estimation unit 210 may include an input means (not illustrated in the drawings) so as to receive an input of a future time, or a designation as to how far in the future the incident occurrence quantitative value to be estimated belongs. The user of the estimation apparatus 200 may designate how far in the future the incident occurrence quantitative value to be estimated by the estimation apparatus 200 belongs, and the estimation unit 210 may estimate the future incident occurrence quantitative value that matches the contents of the designation.

With such a configuration, the same effects as those of the first embodiment can be achieved, and further, it is possible to estimate how far in the future the incident occurrence quantitative value belongs, from the time time(t′) corresponding to the psychological-state/sensibility expressing word W(t′).

<Combination of Modification 1 and Modification 3>

Note that Modification 1 and Modification 3 may be combined. An estimation model as a combination of Modification 1 and Modification 3 may be one of the models described below, for example.

(Example Combination 1)

The estimation model is a model that estimates incident occurrence quantitative values after the time time(t′) and the times corresponding to the incident occurrence quantitative values, with the inputs being two or more psychological-state/sensibility expressing words in time order till the time time(t′), and the times corresponding to the psychological-state/sensibility expressing words or the time difference between those times.

(Example Combination 2)

The estimation model is a model that estimates an incident occurrence quantitative value at a future time, with the inputs being two or more psychological-state/sensibility expressing words in time order till the time time(t′), the times corresponding to the psychological-state/sensibility expressing words or the time difference between those times, and the future time.

(Example Combination 3)

The estimation model is a model that estimates incident occurrence quantitative values after the time time(t′) and the times corresponding to the incident occurrence quantitative values, with the inputs being two or more psychological-state/sensibility expressing words in time order till the time time(t′), the order of inputs (the order of reception) of those psychological-state/sensibility expressing words, and the intervals (time intervals) between the times corresponding to those psychological-state/sensibility expressing words.

(Example Combination 4)

The estimation model is a model that estimates an incident occurrence quantitative value at a future time, with the inputs being two or more psychological-state/sensibility expressing words in time order till the time time(t′), the order of inputs (the order of reception) of those psychological-state/sensibility expressing words, the intervals (time intervals) between the times corresponding to those psychological-state/sensibility expressing words, and the future time.

In the estimation apparatus 200 for a combination of Modification 1 and Modification 3, one of those estimation models is stored beforehand into the estimation model storage unit 211, and the estimation unit 210 obtains and outputs estimation results that are future incident occurrence quantitative values of the subject person and the times corresponding to the incident occurrence quantitative values, or an incident occurrence quantitative value of the subject person at a designated future time.

<Combination of Modification 2 and Modification 3>

Note that Modification 2 and Modification 3 may be combined. An estimation model as a combination of Modification 2 and Modification 3 may be one of the models described below, for example.

(Example Combination 1)

The estimation model is a model that estimates incident occurrence quantitative values after the time time(t′) and the times corresponding to the incident occurrence quantitative values, with the inputs being psychological-state/sensibility expressing words emitted by a plurality of subject persons till the time time(t′), and the times corresponding to the respective psychological-state/sensibility expressing words or the elapsed times since a predetermined time.

(Example Combination 2)

The estimation model is a model that estimates an incident occurrence quantitative value at a future time, with the inputs being psychological-state/sensibility expressing words emitted by a plurality of subject persons till the time time(t′), the times corresponding to the respective psychological-state/sensibility expressing words or the elapsed times since a predetermined time, and the future time.

In the estimation apparatus 200 for a combination of Modification 2 and Modification 3, one of those estimation models is stored beforehand into the estimation model storage unit 211, and the estimation unit 210 obtains and outputs estimation results that are future incident occurrence quantitative values and the times corresponding to the incident occurrence quantitative values, or an incident occurrence quantitative value at a designated future time.

<Modification 4: Other Information>

By taking into consideration other information till a certain time in addition to two or more psychological-state/sensibility expressing words till the certain time, it is possible to increase the accuracy of estimation of incident occurrence quantitative values after the certain time. For example, the other information may be fixed ambient environment information, unfixed ambient environment information, experience information, biological information, communication information, and other information that affects mood. In addition to two or more psychological-state/sensibility expressing words and incident occurrence quantitative values, these pieces of information are additionally used in learning an estimation model. The estimation model obtained through this learning is then used in estimating incident occurrence quantitative values from these pieces of information in addition to two or more psychological-state/sensibility expressing words.

<Learning Apparatus 100>

In addition to the learning unit 110, the psychological-state/sensibility expressing word acquisition unit 120, the location/time acquisition unit 190, the incident information acquisition unit 180, and the storage unit 130, the learning apparatus 100 includes at least one of a fixed ambient environment acquisition unit 141, an unfixed ambient environment acquisition unit 142, an experience information acquisition unit 150, a biological information acquisition unit 170, and a communication information acquisition unit 160 (see FIG. 2).

<Estimation Apparatus 200>

In addition to the estimation unit 210, the psychological-state/sensibility expressing word acquisition unit 220, and the transitory storage unit 230, the estimation apparatus 200 includes at least one of a fixed ambient environment acquisition unit 241, an unfixed ambient environment acquisition unit 242, an experience information acquisition unit 250, a biological information acquisition unit 270, and a communication information acquisition unit 260 (see FIG. 6).

<Fixed Ambient Environment Acquisition Units 141 and 241>

The fixed ambient environment acquisition unit 141 acquires information p_{L}(t) relating to an ambient environment that is fixed and is associated with a location (hereinafter this ambient environment will be also referred to as a “fixed ambient environment”) (S141), and stores the information into the storage unit 130. Likewise, the fixed ambient environment acquisition unit 241 acquires information p(t′) relating to a fixed ambient environment (S241), and stores the information into the transitory storage unit 230. A fixed ambient environment is an ambient environment of the user or the subject person, is an environment uniquely determined by the location, and is an environment that does not change with change in time. For example, a fixed ambient environment may be a category such as “dining facilities” or “play facilities”, or may be a more specific or unique name such as “AA Amusement Park” or “BB zoo”. For example, the learning unit 110 learns an estimation model so as to be able to cope with the influence of a fixed ambient environment on the mood of a person, activities of a person, and interactions between persons, and the estimation unit 210 estimates incident occurrence quantitative values using the estimation model obtained through this learning.

For example, the fixed ambient environment acquisition units 141 and 241 include a GPS function and a database that associates location information with fixed ambient environments, obtain location information via the GPS function, and acquire, from the database, information related to the fixed surrounding environment associated with the location information. Like the psychological-state/sensibility expressing word acquisition unit 120 and the psychological-state/sensibility expressing word acquisition unit 220, the fixed ambient environment acquisition units 141 and 241 may also receive inputs of character strings of fixed ambient environments from the user of the learning apparatus 100 and the user of the estimation apparatus 200.

<Unfixed Ambient Environment Acquisition Units 142 and 242>

The unfixed ambient environment acquisition unit 142 acquires information q′_{L}(t) relating to an ambient environment that is no fixed and is not associated with any location (hereinafter this ambient environment will be also referred to as an “unfixed ambient environment”) (S142), and stores the information into the storage unit 130. Likewise, the unfixed ambient environment acquisition unit 242 acquires information q′(t′) relating to an unfixed ambient environment (S242), and stores the information into the transitory storage unit 230. An unfixed ambient environment is an ambient environment of the user or the subject person, and is an environment that is not uniquely determined by the location, which is an environment that changes with change in time, and is information indicating whether it is morning or night with differences in human activities and brightness, such as meteorological information indicating temperature, humidity, rainfall, earthquake, or the like, for example. For example, the meteorological information and the like change with change in time even at the same location, and accordingly, it is an ambient environment that is not uniquely determined by the location, or is an unfixed ambient environment. For example, the learning unit 110 learns an estimation model so as to be able to cope with the influence of an unfixed ambient environment on the mood of a person, activities of a person, and interactions between persons, and the estimation unit 210 estimates incident occurrence quantitative values using the estimation model obtained through this learning.

For example, the unfixed ambient environment acquisition units 142 and 242 may include a sensor that acquires temperature or the like, and may acquire temperature or the like via the sensor. Like the psychological-state/sensibility expressing word acquisition unit 120 and the psychological-state/sensibility expressing word acquisition unit 220, the unfixed ambient environment acquisition units 142 and 242 may also receive inputs of character strings of unfixed ambient environments from the user of the learning apparatus 100 and the user of the estimation apparatus 200.

<Experience Information Acquisition Units 150 and 250>

The experience information acquisition unit 150 acquires experience information E_{L}(t) relating to an experience of the user (S150), and stores the experience information into the storage unit 130. Likewise, the experience information acquisition unit 250 acquires experience information E(t′) relating to an experience of the subject person (S250), and stores the experience information into the transitory storage unit 230. Experience information is information about a thing experienced by the user or the subject person, and is information indicating whether the user or the subject person has an experience of eating a certain food, an experience of listening to a certain piece of music, an experience of playing a certain game, or the like, for example. The learning unit 110 learns an estimation model so as to be able to cope with the influence of experience information on the mood of a person, activities of a person, and interactions between persons, for example, and the estimation unit 210 estimates incident occurrence quantitative values using the estimation model obtained through this learning.

For example, the experience information acquisition units 150 and 250 include a GPS function and a database that associates location information with facilities (such as restaurants, concert venues, and attraction facilities) for providing predetermined experiences, obtain location information via the GPS function, and acquire, from the database, information indicating a predetermined experience to be provided at the facility associated with the location information. Like the psychological-state/sensibility expressing word acquisition unit 120 and the psychological-state/sensibility expressing word acquisition unit 220, the experience information acquisition units 150 and 250 may also receive inputs of character strings of experience information from the user of the learning apparatus 100 and the user of the estimation apparatus 200.

<Biological Information Acquisition Units 170 and 270>

The biological information acquisition unit 170 acquires biological information B_{L}(t) about the user (S170), and stores the biological information into the storage unit 130. Likewise, the biological information acquisition unit 270 acquires biological information B(t′) about the subject person (S270), and stores the biological information into the transitory storage unit 230. Biological information is information about a body activity of the user or the subject person, and is information indicating a heartbeat, respiration, a facial expression, or the like, for example. The learning unit 110 learns an estimation model so as to be able to cope with the influence of biological information on the mood of a person, activities of a person, and interactions between persons, for example, and the estimation unit 210 estimates incident occurrence quantitative values using the estimation model obtained through this learning.

For example, the biological information acquisition units 170 and 270 have a function of acquiring biological information, and acquire biological information. The biological information acquisition units 170 and 270 have an application compatible with a wearable device such as hitoe (registered trademark), for example, and acquire biological information about the user and the subject person.

<Communication Information Acquisition Units 160 and 260>

The communication information acquisition unit 160 acquires communication information C_{L}(t) relating to communication of the user (S160), and stores the communication information into the storage unit 130. Likewise, the communication information acquisition unit 260 acquires communication information C(t′) relating to communication of the subject person (S260), and stores the communication information into the transitory storage unit 230. Communication information is information about communication between the user or the subject person and another person, and is information indicating who the user has met, a facial expression of the user, a facial expression of the person the user has met, or the like, for example. The learning unit 110 learns an estimation model so as to be able to cope with the influence of communication information on the mood of a person, activities of a person, and interactions between persons, for example, and the estimation unit 210 estimates incident occurrence quantitative values using the estimation model obtained through this learning.

For example, the communication information acquisition units 160 and 260 have a photographing function, a face authentication function, and a facial expression detection function, capture an image or a video image containing the user or the subject person with the photographing function, perform face authentication on a person with the face authentication function to obtain information indicating the user or the subject person and information indicating the person the user or the subject person is meeting, and detect a facial expression of the person the user or the subject person is meeting, or a facial expression of the user or the subject person with the facial expression detection function, to obtain information indicating a facial expression. Further, in a case where there is a function or the like that allows the user or the subject person and the person the user or the subject person is meeting to exchange information indicating their identities with each other, information indicating the person the user or the subject person is meeting may be obtained through the function. Like the psychological-state/sensibility expressing word acquisition unit 120 and the psychological-state/sensibility expressing word acquisition unit 220, the communication information acquisition units 160 and 260 may also receive inputs of character strings of communication information from the user of the learning apparatus 100 and the user of the estimation apparatus 200.

<Learning Unit 110>

When a sufficient amount of the learning psychological-state/sensibility expressing words to learn the estimation model for the region as the target, the learning incident occurrence quantitative values corresponding to the words, and (i) to (v) listed below are accumulated in the storage unit 130 (S110-1), the learning unit 110 extracts, for the region as the target, the learning psychological-state/sensibility expressing words, the learning incident occurrence quantitative values corresponding to the words, and (i) to (v) from the storage unit 130, learns the estimation model (S110), and outputs the learned estimation model.

(i) Information relating to a fixed ambient environment uniquely determined by the location of the person who has made the input at the time of an input of a psychological-state/sensibility expressing word

(ii) Information relating to an ambient environment of the person who has made the input at the time of an input of a psychological-state/sensibility expressing word, the ambient environment being not uniquely determined by the location, or being an ambient environment that changes with change in time

(iii) Experience information relating to an experience of the person who has made the input at the time of an input of a psychological-state/sensibility expressing word

(iv) Biological information about the person who has made the input at the time of an input of a psychological-state/sensibility expressing word

(v) Communication information relating to communication of the person who has made the input at the time of an input of a psychological-state/sensibility expressing word

Note that the learning unit 110 does not need to perform learning using all of (i) to (v), and each of the components described above is only required to acquire information necessary for estimation. The storage unit 130 then stores the information, and learning is performed on the basis of the information stored in the storage unit 130. That is, the learning unit 110 is only required to use at least one time series among (i) to (v). The estimation model according to this modification is a model to be used when the estimation apparatus 200 estimates incident occurrence quantitative values after the time time(t′) in the target region, with the inputs being two or more psychological-state/sensibility expressing words emitted in the target region in time order till the time time(t′), and at least one time series among (i) to (v) corresponding to the respective psychological-state/sensibility expressing words.

<Estimation Unit 210 and Estimation Model Storage Unit 211>

The learned estimation model for the target region outputted by the learning apparatus 100 of this modification is stored beforehand into the estimation model storage unit 211. The estimation unit 210 extracts two or more psychological-state/sensibility expressing words emitted in the target region from the transitory storage unit 230, and at least one of (i) to (v) that correspond to the respective psychological-state/sensibility expressing words and were used in the learning performed by the above-described learning unit 110, estimates future incident occurrence quantitative values of the target region from the two or more psychological-state/sensibility expressing words emitted in the target region and at least one of (i) to (v) corresponding to the respective psychological-state/sensibility expressing words, using the learned estimation model stored beforehand in the estimation model storage unit 211 (S210), and outputs the estimation results.

<Effects>

According to Modification 4, with the configuration described above, the same effects as those of the first embodiment can be achieved. Furthermore, with at least one of (i) to (v) being taken into consideration, incident occurrence quantitative values can be estimated more accurately. Note that this modification and Modifications 1 to 3 may be combined.

Note that, in this modification, the timings at which the respective pieces of information are acquired by the fixed ambient environment acquisition units 141 and 241, the unfixed ambient environment acquisition units 142 and 242, the experience information acquisition units 150 and 250, the biological information acquisition units 170 and 270, and the communication information acquisition units 160 and 260 are the same as the timings at which psychological-state/sensibility expressing words are acquired by the psychological-state/sensibility expressing word acquisition unit 120 and the psychological-state/sensibility expressing word acquisition unit 220. However, the timings may vary with each acquisition unit. Each piece of information at the timing closest to the timing at which a psychological-state/sensibility expressing word is acquired may be used, insufficient information may be complemented, or extra information may be removed.

<Modification 5>

In the first embodiment, the user of the learning apparatus 100 and the user of the estimation apparatus 200 input character strings of onomatopoeia. However, character strings are not necessarily inputted.

For example, drawings, images, or the like associated with onomatopoeic words in one-to-one correspondence may be inputted. In this case, the psychological-state/sensibility expressing word acquisition units 120 and 220 may include a database that associates onomatopoeic words with drawings, images, or the like, receive an input of a drawing, an image, or the like, and extract, from the database, the character string of the onomatopoeic word corresponding to the received drawing, image, or the like.

Further, the psychological-state/sensibility expressing word acquisition units 120 and 220 may receive an input of the character string of an onomatopoeic word by automatically extracting the character string of the onomatopoeic word included in the result of voice recognition performed on an utterance of the subject person, for example. The psychological-state/sensibility expressing word acquisition units 120 and 220 may include a speech recognition unit (not illustrated), for example, receive an input of a speech signal in place of the character string of an onomatopoeic word, cause the speech recognition unit to perform speech recognition processing to obtain the character strings in the speech recognition result, extract the character string of an onomatopoeic word from among the character strings in the speech recognition result, and output the character string of the onomatopoeic word. For example, the psychological-state/sensibility expressing word acquisition units 120 and 220 include a database that stores the character strings of onomatopoeic words of interest, and refer to the database to extract the character string of an onomatopoeic word from among the character strings in a speech recognition result.

Further, in an estimation phase, the character string of an onomatopoeic word that has been automatically extracted from among text character strings inputted when the subject person wrote an email message or wrote a comment to be posted on a website may be used as an input, or the character string of an onomatopoeic word that has been automatically extracted from a result of speed recognition performed on the voice of the subject person when the subject person was talking on a mobile phone or the like may be used as an input, for example. Furthermore, in a learning phase, if there is a time-series object (a text character string inputted when an e-mail message was written or a comment to be posted on a website was written, or a speech recognition result) that has been emitted from the same person who is not necessarily the subject person and is accompanied by location information and times, the learning unit 110 can perform learning using the time-series object.

Note that this modification and Modifications 1 to 4 may be combined.

<Other Modifications>

The present invention is not limited to the above-described embodiments and modifications, and changes can be made to them as appropriate, without departing from the scope of the present invention.

<Program and Recording Medium>

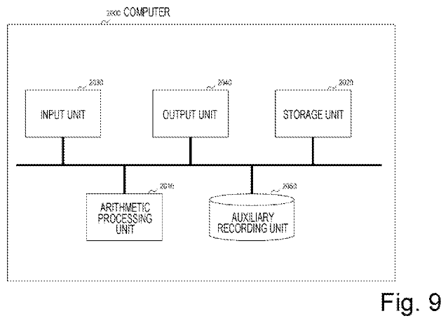

The above various kinds of processing can be implemented by loading a program for executing the respective steps of the above method into a storage unit 2020 of a computer illustrated in FIG. 9 and operating an arithmetic processing unit 2010, an input unit 2030, an output unit 2040, and the like.

The program in which the processing contents are written can be recorded in a computer-readable recording medium. The computer-readable recording medium is a non-transitory recording medium, for example, and is specifically a magnetic recording device, an optical disk, a magnetooptical recording medium, or the like.

Also, distribution of the program is conducted by selling, transferring, or renting a portable recording medium such as a DVD or a CD-ROM on which the program is recorded, for example. Further, the program may be stored in a storage device in a server computer, and the program may be transferred from the server computer to other computers via a network so that the program can be distributed.

The computer that executes such a program first temporarily stores the program recorded in a portable recording medium or the program transferred from a server computer into an auxiliary recording unit 2050 that is a non-transitory storage device of the computer, for example. At the time of execution of the processing, the computer then reads the program stored in the auxiliary recording unit 2050, which is the non-transitory storage device of the computer, into the storage unit 2020, and performs the processing according to the read program. Further, in another embodiment of this program, the computer may directly read the program from a portable recording medium into the storage unit 2020, and perform processing according to the program. Furthermore, the computer may sequentially perform processing according to the received program each time the program is transferred from the server computer to the computer. Alternatively, the above processing may be performed by a so-called application service provider (ASP) service that achieves a processing function only by issuing an instruction to execute the program and acquiring the result, without transfer of the program from the server computer to the computer. Note that the program according to the present mode includes information that is to be subjected to processing to be performed by an electronic calculator and conforms to the program (data or the like that is not a direct command for the computer but characteristically defines the processing to be performed by the computer).

Although this device is formed with a computer executing a predetermined program in this mode, at least part of the processing contents may be realized by hardware.

1-10. (canceled)

11. A learning apparatus comprising:
a memory that stores at least a learning psychological-state/sensibility expressing word emitted in a predetermined region, and a learning incident occurrence quantitative value that is a quantitative value of an occurrence of a predetermined event that occurred in the region when the learning psychological-state/sensibility expressing word was emitted; and
processing circuitry configured to learn an estimation model for estimating an incident occurrence quantitative value after a certain time in the region, with an input being only a time series of two or more psychological-state/sensibility expressing words emitted before the certain time in the region, using a plurality of sets of learning data, one set of learning data being a combination including only a time series of two or more learning psychological-state/sensibility expressing words emitted in the region before a time time(t) and a learning incident occurrence quantitative value in the region after the time time(t).

12. A learning apparatus comprising:
a memory that stores at least a learning psychological-state/sensibility expressing word emitted by a plurality of persons in a predetermined region, a time for learning at which the learning psychological-state/sensibility expressing word was emitted, and a learning incident occurrence quantitative value that is a quantitative value of an occurrence of a predetermined event that occurred in the region when the learning psychological-state/sensibility expressing word was emitted; and
processing circuitry configured to learn an estimation model for estimating an incident occurrence quantitative value after a certain time in the region, with inputs being only a plurality of psychological-state/sensibility expressing words emitted by a plurality of persons in the region before the certain time, and times corresponding to the respective psychological-state/sensibility expressing words or elapsed times since a predetermined time, using a plurality of sets of learning data, one set of learning data being a combination including only a plurality of learning psychological-state/sensibility expressing words emitted by a plurality of persons in the region before a time time(t), times for learning corresponding to the respective learning psychological-state/sensibility expressing words or elapsed times since a predetermined time, and a learning incident occurrence quantitative value after the time time(t) in the region.

13. The learning apparatus according to claim 11 or 12, wherein
the psychological-state/sensibility expressing word is onomatopoeia.

14. An estimation apparatus comprising
processing circuitry configured to estimate a future incident occurrence quantitative value in a predetermined region only on a basis of two or more inputted psychological-state/sensibility expressing words emitted in the region and an input order of the two or more psychological-state/sensibility expressing words, using an estimation model for estimating an incident occurrence quantitative value that is a quantitative value of an occurrence of a predetermined event in the region after a certain time, with an input being only a time series of two or more psychological-state/sensibility expressing words emitted in the region before the certain time.

15. An estimation apparatus comprising
processing circuitry configured to estimate a future incident occurrence quantitative value in a predetermined region only on a basis of a plurality of psychological-state/sensibility expressing words emitted by a plurality of persons in the region, and times corresponding to the respective psychological-state/sensibility expressing words or elapsed times since a predetermined time, using an estimation model for estimating an incident occurrence quantitative value that is a quantitative value of an occurrence of a predetermined event in the region after a certain time, with inputs being only a plurality of psychological-state/sensibility expressing words emitted by a plurality of persons before the certain time in the region, and times corresponding to the respective psychological-state/sensibility expressing words or elapsed times since a predetermined time.

16. The estimation apparatus according to claim 14 or 15, wherein
the psychological-state/sensibility expressing word is onomatopoeia.

17. The estimation apparatus according to claim 14 or 15, wherein
the estimation model is a model for estimating an incident occurrence quantitative value after the certain time in the region, with an input being at least one piece of:
experience information relating to an experience; or
communication information relating to communication, and
the processing circuitry configured to use the estimation model, and estimate the future incident occurrence quantitative value in the region, on a basis of at least one piece of:
experience information relating to an experience of a person who has made an input at a time of the input of a psychological-state/sensibility expressing word; or
communication information relating to communication of a person who has made an input at a time of the input of a psychological-state/sensibility expressing word.

18. The estimation apparatus according to claim 14 or 15, wherein
the estimation model is a model for estimating an incident occurrence quantitative value after the certain time in the region, also using the biological information as an input, and
the processing circuitry configured to use the estimation model, and estimate the future incident occurrence quantitative value in the region also on a basis of the biological information about the person who has made the input at the time of the input of a psychological-state/sensibility expressing word.

19. A learning method, implemented by a learning apparatus that includes a memory and processing circuitry, comprising:
a storage step in which the memory stores at least a learning psychological-state/sensibility expressing word emitted in a predetermined region, and a learning incident occurrence quantitative value that is a quantitative value of an occurrence of a predetermined event that occurred in the region when the learning psychological-state/sensibility expressing word was emitted; and
a learning step in which the processing circuitry learns an estimation model for estimating an incident occurrence quantitative value after a certain time in the region, with an input being only a time series of two or more psychological-state/sensibility expressing words emitted before the certain time in the region, using a plurality of sets of learning data, one set of learning data being a combination including only a time series of two or more learning psychological-state/sensibility expressing words emitted in the region before a time time(t) and a learning incident occurrence quantitative value in the region after the time time(t).

20. A learning method, implemented by a learning apparatus that includes a memory and processing circuitry, comprising:
a storage step in which the memory stores at least a learning psychological-state/sensibility expressing word emitted by a plurality of persons in a predetermined region, a time for learning at which the learning psychological-state/sensibility expressing word was emitted, and a learning incident occurrence quantitative value that is a quantitative value of an occurrence of a predetermined event that occurred in the region when the learning psychological-state/sensibility expressing word was emitted; and
a learning step in which the processing circuitry learns an estimation model for estimating an incident occurrence quantitative value after a certain time in the region, with inputs being only a plurality of psychological-state/sensibility expressing words emitted by a plurality of persons in the region before the certain time, and times corresponding to the respective psychological-state/sensibility expressing words or elapsed times since a predetermined time, using a plurality of sets of learning data, one set of learning data being a combination including only a plurality of learning psychological-state/sensibility expressing words emitted by a plurality of persons in the region before a time time(t), times for learning corresponding to the respective learning psychological-state/sensibility expressing words or elapsed times since a predetermined time, and a learning incident occurrence quantitative value after the time time(t) in the region.

21. An estimation method, implemented by an estimation apparatus that includes processing circuitry, comprising
an estimation step in which the processing circuitry estimates a future incident occurrence quantitative value in a predetermined region only on a basis of two or more inputted psychological-state/sensibility expressing words emitted in the region and an input order of the two or more psychological-state/sensibility expressing words, using an estimation model for estimating an incident occurrence quantitative value that is a quantitative value of an occurrence of a predetermined event in the region after a certain time, with an input being only a time series of two or more psychological-state/sensibility expressing words emitted in the region before the certain time.

22. An estimation method, implemented by an estimation apparatus that includes processing circuitry, comprising
an estimation step in which the processing circuitry estimates a future incident occurrence quantitative value in a predetermined region only on a basis of a plurality of psychological-state/sensibility expressing words emitted by a plurality of persons in the region, and times corresponding to the respective psychological-state/sensibility expressing words or elapsed times since a predetermined time, using an estimation model for estimating an incident occurrence quantitative value that is a quantitative value of an occurrence of a predetermined event in the region after a certain time, with inputs being only a plurality of psychological-state/sensibility expressing words emitted by a plurality of persons before the certain time in the region, and times corresponding to the respective psychological-state/sensibility expressing words or elapsed times since a predetermined time.

23. A non-transitory computer-readable recording medium having recorded thereon a program for causing a computer to function as the learning apparatus according to claim 11 or 12, or the estimation apparatus according to claim 14 or 15.
